(19) United States
(12) Patent Application Publication
(10) Pub. No.: US 2023/0347498 A1
(43) Pub. Date: Nov. 2, 2023

(54) Elastomeric Storage Device for Organizing Hex Bit Tools

(71) Applicant: Dan Steinberg, Blacksburg, VA (US)

(72) Inventor: Dan Steinberg, Blacksburg, VA (US)

(21) Appl. No.: 18/126,370

(22) Filed: Mar. 24, 2023

Related U.S. Application Data
(60) Provisional application No. 63/323,473, filed on Mar. 24, 2022.
(60) Provisional application No. 63/356,048, filed on Jun. 28, 2022.

(51) Int. Cl. B25H 3/00; B25H 3/04

(52) U.S. Cl. CPC B25H 3/003; B25H 3/04

(57) ABSTRACT

A storage device for hex bits with an annular groove 22. The storage device comprises an elastomeric sheet with holes that mate with the annular groove. The holes are sized such that the annular groove is at least partially occupied by the elastomeric sheet when the annular groove is disposed in the hole. The holes have a minimum diameter that is smaller than a major diameter or minor diameter of the hexagonal portion of the hex bit. The hex bit is retained in the hole because removing the hex bit requires stretching/deformation of the elastomeric sheet. The holes can have an hourglass shape. The holes can be symmetrical or asymmetrical. The holes can be non-circular, such as polygonal, square, or triangular. The elastomeric sheet can be made of rubber.

### FIELD OF THE INVENTION

The present invention relates generally to tool storage devices and particularly to a device for storing and organizing hex bits.

### BACKGROUND OF THE INVENTION

Hex bits are tools having a hexagonal base and a tip that can be a driver or other tool. For example, hex bits can have tips that are screwdrivers, twist drills, nut drivers, grinders or a wide variety of other tools. Hex bits can also function as adapters to make connections with other tooling systems, such as ¼″, ⅜″ or ½″ square drives (e.g. for sockets for rotating hex-head bolts). FIG. 1 shows a hex bit with a phillips head screwdriver tip 20 as known in the art.

The hex bit shown in FIG. 1 has an annular groove 22 near a base end 24. The annular groove 22 functions to retain the hex bit in a driver tool (not shown) such as an impact driver.

Hex bits have enjoyed an increasing diversity of applications in recent years, resulting in an increased need for improved ways for storing and organizing hex bits. Currently-available devices for hex bit storage have problems such as high cost, large size, rigid construction, inadequate holding force, and inconsistent holding force. The holding force problem is especially problematic. Some storage devices hold the bits so tightly that they cannot be easily removed by hand, and others hold the bits so loosely that bits fall out from the weight of the hex bit. Some storage devices have both excessively tight and excessively loose receptacles in the same device.

Some hex bit storage devices have magnets for retaining hex bits, and magnets do provide consistent holding force. However, the holding force provided by magnets is weak, and so cannot retain larger hex bits such as twist drills or adapters. Magnets are also costly.

Another problem with some storage devices is that receptacles can become loose over time, with use.

There is a long-felt need for improved hex bit storage devices. In particular, there is a need for hex bit storage devices with consistent and reliable holding force suitable for holding hex bits with a wide range of weights and sizes.

### SUMMARY

The present invention includes a hex bit storage device comprising a hex bit and an elastomeric sheet. The hex bit has an annular groove and a minor diameter. The elastomeric sheet has a hole with a minimum inner diameter that is less than the minor diameter of the hex bit. The annular groove is disposed in the hole. This size relationship assures that flexing and deformation of the elastomeric sheet is necessary for inserting and removing the hex bit.

The hole can have an hourglass shape or asymmetrical hourglass shape.

The elastomeric sheet can have a hardness of about 20-60 shore A.

The elastomeric sheet can have a thickness equal to or less than a length of the annular groove (as measured in the plane of the major diameter).

The storage device can also have a transverse hole that extends generally parallel with the elastomeric sheet. The transverse hole can be used to hang or attach the storage device to something.

The storage device can also have an expanded end with a thickness greater than the thickness of the elastomeric sheet.

The present invention also includes a storage device comprising an elastomeric sheet with a hole for storing hex bits. The hole is sized and shaped such that the elastomeric sheet overlaps a cross sectional groove area of the annular groove by at least 20% or 40%. The cross sectional groove area can be defined in a plane of a major diameter or minor diameter of the hex bit (defined below).

The present invention also includes a storage device designed to fit hex bits with an annular groove having dimensions according to ASME B107.4, which is a mechanical standard for hex bit tools. Specifically, the elastomeric sheet has a hole shaped and sized such that when a ASME B107.4-complient annular groove is disposed in the hole, the elastomeric sheet overlaps at least 20% 40% or 50% of a cross sectional groove area.

The present invention also includes a storage device comprising an elastomeric sheet with holes, wherein the holes are shaped and sized to occupy a specified percentage of the volume of the annular groove. The elastomeric sheet can occupy at least 10%, 20%, 30%, 40%, 60% or 80% of the annular groove volume.

The present invention also includes a storage device comprising an elastomeric sheet with holes, wherein the holes are shaped and sized to occupy a specified percentage of the volume of an annular groove with dimensions according to ASME B107.4. The elastomeric sheet can occupy at least 10%, 20%, 30%, 40%, 60% or 80% of the volume of a ASME B107.4-compliant annular groove.

### DESCRIPTION OF THE FIGURES

FIG. 1 (Prior Art) shows a hex bit with an annular groove and a phillips head screwdriver tip.

FIG. 2 shows a perspective view of a hex bit storage device according to the present invention. The device of FIG. 2 has ten holes, with each hole capable of holding one hex bit.

FIG. 3 shows a cross sectional view of two hex bits retained in the present storage device.

FIG. 4 shows a cross sectional view of a hex bit, illustrating the major diameter and minor diameter.

FIG. 5 shows a hex bit with an annular groove, illustrating the annular groove diameter and length.

FIGS. 6A-6F show hole shape variations within the scope of the invention and claims.

FIGS. 7A-7B illustrate and define the cross sectional groove area for the annular groove. The minor diameter and major diameter each have a different cross sectional groove area.

FIG. 8 illustrates and defines an overlap area, an area of overlap between the cross sectional groove area and the elastomeric sheet when a hex bit is retained in the hole.

FIG. 9 shows dimensions of an annular groove for a ¼-inch hex bit, according to the B107.4 standard published by the American Society for Mechanical Engineering.

FIG. 10 shows an embodiment of the storage device with a hole having vertical sidewalls, and illustrates an overlap area for this embodiment.

FIG. 11 shows an embodiment of the present invention having triangular and square holes for storing hex bits.

FIG. 12 shows two cross sectional views of the annular groove.

FIG. 13 shows a hex bit retained in a triangual hole according to the present invention.

FIG. 14 shows a hex bit retained in a triangular hole with a different rotational orientation than in FIG. 13.

FIG. 15 shows a hex bit retained in a square hole according to the present invention.

FIG. 16 shows a storage device according to the present invention with one hole for holding a hex bit, and a loop hole for hanging or attachment to something.

FIG. 17 shows a storage device according to the present invention with two transverse holes, and an optional wire hanger.

FIG. 18 shows a storage board with pins for storing multiple hex bit storage devices having transverse holes.

FIG. 19 shows a storage board with concave receptacles for storing multiple hex bit storage devices having expanded ends.

FIG. 20 shows a side view of a storage device according to the present invention having a rigid plate attached to the elastomeric sheet.

FIG. 21 shows a top view of the embodiment shown in FIG. 20.

FIG. 22 shows a storage device according to the present invention having a spacer and screw for attaching to a surface.

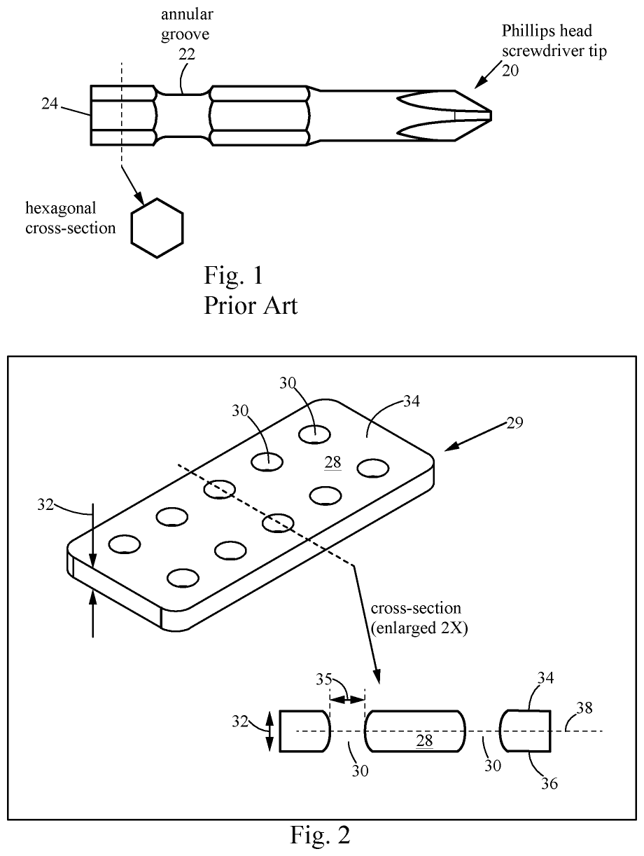

### DETAILED DESCRIPTION

The present invention provides a hex bit storage device comprising a sheet of elastomeric material (e.g. rubber) with holes. The holes extend through the elastomeric sheet. Each hole is sized and shaped to grasp an annular groove of a hex bit. The holes are sized such that the sheet at least partially occupies the volume of the annular groove. Accordingly, each hole can hold one hex bit. The hole can be sized and shaped to achieve a desired holding force. The holes can have an hourglass shape for example. In use, the hex bit is inserted into the holder by pressing the bit into the hole, and the hex bit is removed by pulling. The present device can be made of many possible elastomeric materials including nitrile/buna-N, neoprene, silicone, styrene-butadiene rubber, ethylene propylene diene monomer, butyl rubber, rubber-plastic mixtures or combinations, and thermoplastic rubber materials. The present hex bit storage device can be made by molding or die-cutting/punching for example. The present hex bit storage device can be made of solid or foamed elastomeric material.

FIG. 2 shows a perspective view and cross sectional view of a hex bit storage device 29 according to the present invention. The storage device comprises an elastomeric sheet 28 with ten holes 30 extending through the sheet. The elastomeric sheet has a thickness 32, a top surface 34 and a bottom surface 36. In the specific embodiment of FIG. 2, the holes 30 have an “hourglass” cross sectional shape. An “hourglass shape” means that the hole diameter is smallest at approximately a center plane 38, and the hole diameters are increase near top and bottom surfaces 34 36. The holes 30 have a minimum inner diameter 35.

In the embodiment of FIG. 2, all ten holes 30 are identical, but this is optional. The holes 30 can have different sizes and shapes for holding a variety of hex bits. Also, the holes 30 are illustrated as being symmetrical across the center plane 38, but the present invention and appended claims do not require symmetrical holes.

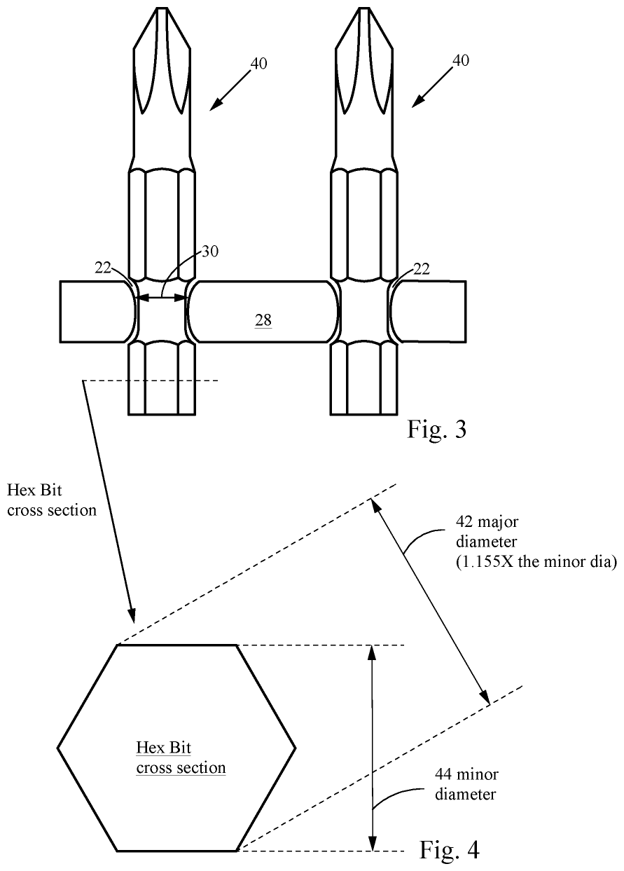

FIG. 3 shows a cross sectional view of the present hex bit storage device holding two hext bits 40. The holes 30 have diameters small enough such that force is required to insert or remove the hex bits 40 from the holes. The holes 30 lock onto the annular groove 22.

The elastomeric material comprising the present storage device can have a range of hardness values. In some embodiments, the elastomeric material has a hardness in the range of about 20-60 or 30-50 on the shore A hardness (durometer) scale. Hardness of about 35-45 shore A works particularly well. The elastomeric material comprising the present storage device can be made of solid rubber, foam rubber, or thermoplastic rubber for example. Suitable rubber materials include include nitrile/buna-N rubber, butyl rubber, polychloroprene (neoprene), and styrene-butadiene rubber.

FIG. 4 shows a cross sectional view of a hexagonal portion of the hex bit. The cross sectional shape is hexagonal. Accordingly, the hex bit hexagon has a major diameter 42 and a minor diameter 44. The major diameter is 1.155× the size of the minor diameter. For a ¼″ nominal size hex bit, the minor diameter is ¼″ nominal.

In the present invention, the minimum hole diameter 35 must be smaller than the major diameter 42 of the hex bit 40. Preferably in the invention, the minimum hole diameter 35 is smaller than the minor diameter 44.

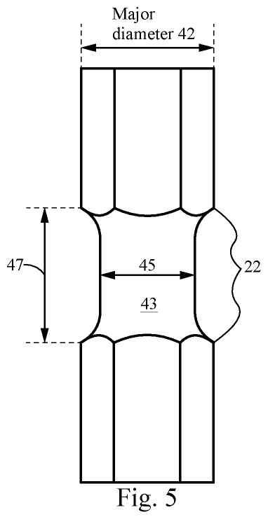

FIG. 5 is a closeup view of the annular groove 22. The annular groove 22 circumscribes a waist 43 of the hex bit. The waist has a diameter 45. The annular groove has a length 47, which is measured in the plane of the major diameter 42.

Hex bit annular grooves 22 generally manufactured according to an international size standard published by the American Society of Mechanical Engineers (ASME), in publication B107.4 (“Driving And Spindle Ends For Portable Hand, Impact, Air, And Electric Tools”). According to ASME B107.4, the waist diameter 45 for ¼″ hex bits is 3/16″. Standards for other hex bit sizes ( 5/16″, 7/16″, ⅝″, and ¾″) are also provided in ASME B107.4. In some embodiments of the invention, the minimum hole diameter 35 can be made to approximately match the waist diameter 45. For example, the minimum hole diameter 35 for holding ¼″ hex bits can be about 0.170-0.200 inches. The minimum hole diameter 35 can match the waist diameter 45 to within 5%, 10%, or 15%. The minimum hole diameter 35 can be larger or smaller than the waist diameter 45.

The thickness 32 can be selected according to the size of the hex bits to be stored. For example, for storing ¼″ hex bits, the thickness can be about ⅛ to ¼ inch. A thickness of about 3/16 works well for storing ¼ inch hex bits. Preferably, the thickness 32 is about equal to or 10% or 20% smaller than the annular groove length 47. For ¼″ hex bits. The annular groove length 47 of ¼-inch hex bits is typically about 0.19-0.24 inches.

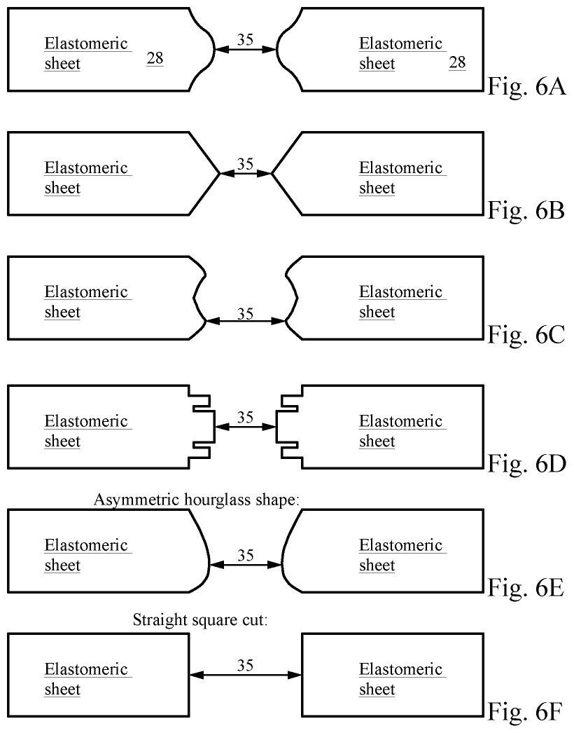

The holes 30 of the present hex bit storage device can have a wide variety of cross sectional shapes. FIGS. 6A-6F show several possible hole shapes within the scope of the present invention and appended claims. FIG. 6E shows an asymmetrical hourglass shape. Asymmetrical hourglass hole shapes perform well in the present hex bit storage device. It is noted that asymmetrical hourglass hole shapes can be produced by punch cutting of an elastomeric sheet. Specifically for example, an elastomeric sheet about 3/16″ thick and having a hardness of 40 shore A and cut with a ¼″ circular punch will produce an asymmetric hourglass with a shape approximately like that shown in FIG. 6E. Any of the hole shapes shown in FIGS. 6A-6F can be made by molding.

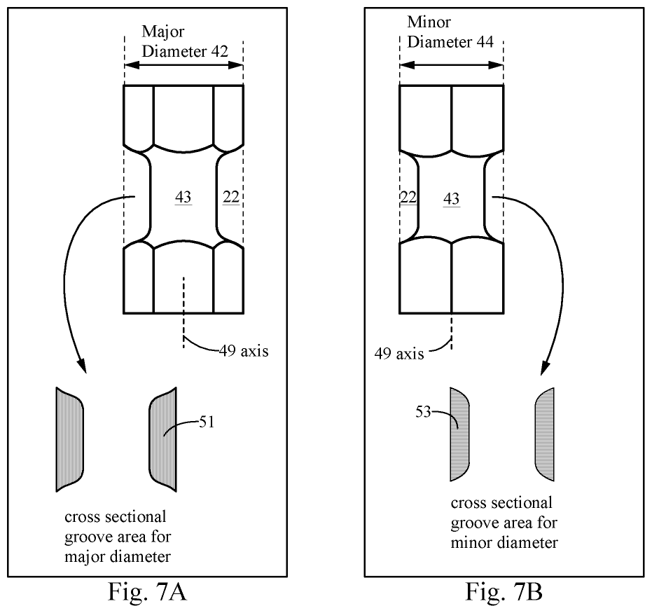

In the present claims, reference is made to a “cross sectional groove area” of the annular groove 22. FIGS. 7A and 7B define and explains the cross sectional groove area. FIG. 7A illustrates a cross sectional groove area 51 in the plane of the major diameter 42, and FIG. 7B illustrates a cross sectional groove area 53 in the plane of the minor diameter 44. The cross sectional groove areas 51 53 are the apparent surface areas of the annular groove when viewed from the side (i.e. when viewed perpendicular to an axis 49 of the hex bit). The cross sectional groove area 51 for the major diameter 42 is always larger than the cross sectional groove area 53 for the minor diameter 44. The cross sectional groove areas 51 53 are not specifically indicated by ASME B107.4, but annular grooves with dimensions according to ASME B107.4 will have definite values for the cross sectional groove areas 51 53.

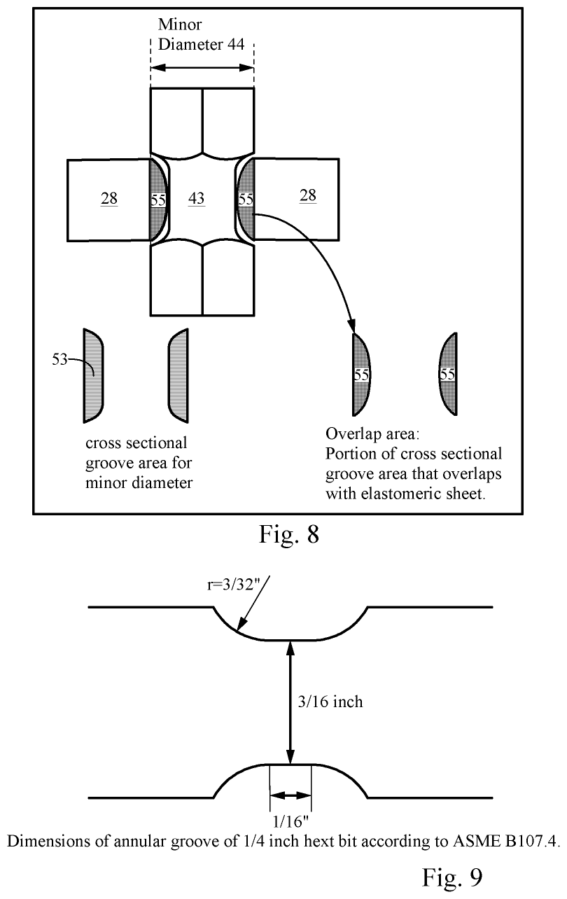

FIG. 8 illustrates an overlap area 55 between the annular groove and the present hex bit holder. In some aspects of the present invention, the overlap area 55 comprises at least a certain percentage of the cross sectional groove area (major or minor) 51 53 when an annular groove is disposed in the hole 30. In the specific example of FIG. 8, the cross sectional groove area (of the minor diameter) comprises about 18 units of surface area (arbitrary units), and the overlap area comprises about 12.2 units of surface area. Hence, the overlap percentage in this specific example is about 12.2/18=68%.

In the present invention, the overlap percentage can be at least 20%, 30%, 40%, 50%, 60%, 70%, 80%, or 90%. High overlap percentage will tend to provide higher retention and insertion force of the hex bit than lower overlap percentage. Overlap percentage of at least about 40% or 60% is preferred in most applications. It is noted that overlap with the cross sectional groove area of the major diameter is defined and measured in the same manner.

FIG. 9 shows the dimensions for an annular groove according to ASME B107.4. In another aspect of the present invention, the holes 30 are shaped and sized such that the overlap percentage is at least 20%, 30%, 40%, 50%, 60%, 80% or 90% when an annular groove with dimensions according to the ASME B107.4 standard is disposed in the hole. FIG. 9 does not show aspects of the B107.4 standard external to the annular groove.

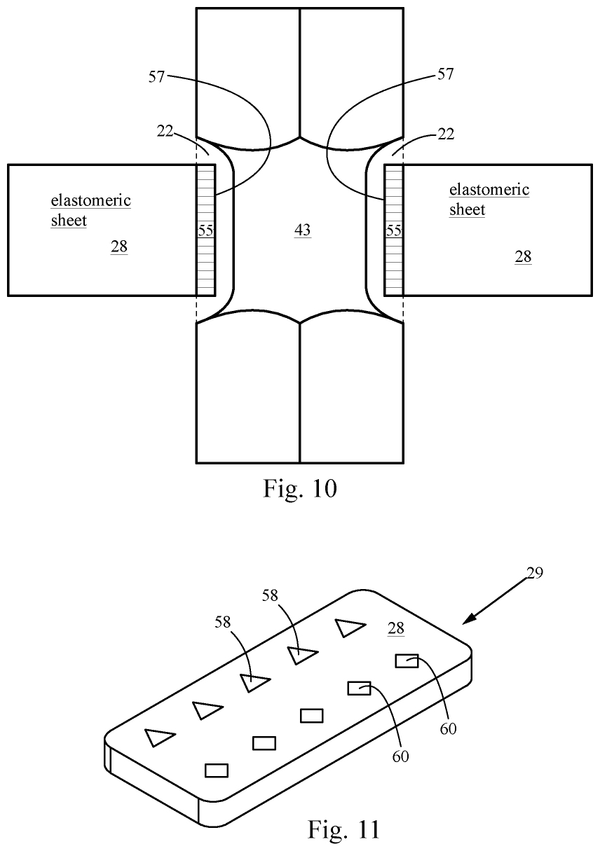

FIG. 10 shows a cross sectional side view of the annular groove 22 disposed in a hole having straight, vertical sidewalls 57. The overlap area 55 is shown.

FIG. 11 shows an embodiment of the present invention having triangular holes 58 and square holes 60 for holding hex bits. In embodiments with non-circular holes such as this, the 2-dimensional overlap area 55 can be indefinite. Accordingly, embodiments with non-circular holes are described in terms of a volumetric overlap between an annular groove volume and the elastomeric sheet. The volumetric overlap is the portion of the annular groove volume that is occupied by the elastomeric sheet when the annular groove 22 is disposed in one of the holes 58 60.

FIG. 12 illustrates the 3-dimensional volume of the annular groove with two cross-sectional vies. FIG. 12 shows both a side view and a cross section of the annular groove 22 and waist 43. The annular groove 22 has a 3-dimensional volume, bounded by the waist 43, and hexagonal surface 50. In other words, the annular groove 22 is the empty space between the waist 43 and the hexagonal surface 50.

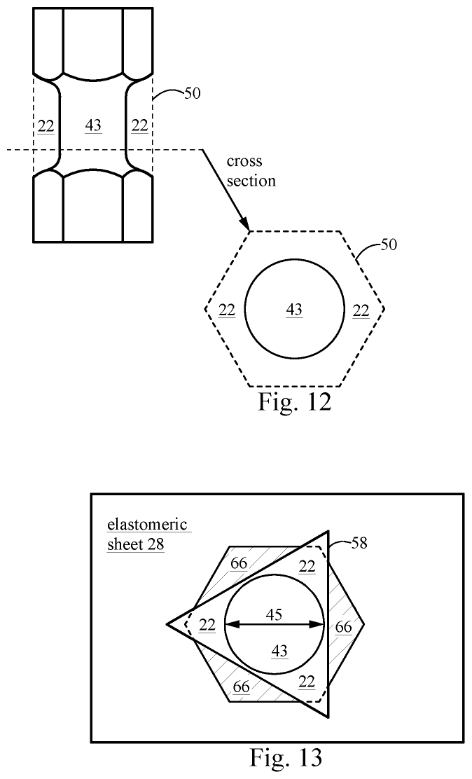

FIG. 13 shows a cross sectional view of the hex bit retained within the triangular hole 58. The elastomeric sheet 28 occupies the regions 66 of the annular groove 22. Occupied regions 66 may comprise 20%, 30%, 40%, 50%, 60%, 70%, 80%, or 90% of the total 3-dimensional volume of the annular groove.

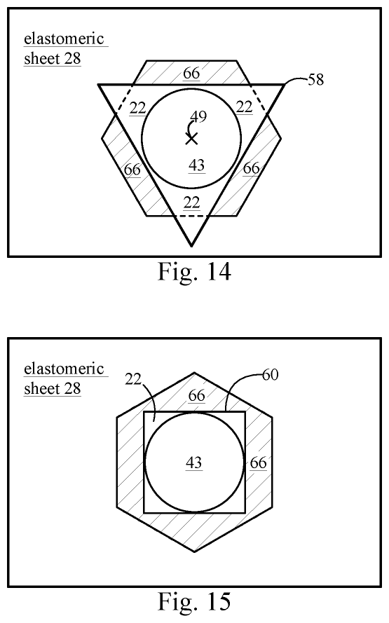

FIG. 14 shows a cross sectional view of the hex bit retained in the triangular hole 58, in which the hex bit has a different rotational orientation (i.e. rotated about axis 49) compared to FIG. 13. It is noted that as the hex bit is rotated about axis 49, the occupied regions 66 may change in shape and volume (depending on the shape and size of the hole). Accordingly, in the appended claims, the occupied regions must have a minimum value for any rotational orientation of the hex bit. The minimum occupied volume is expressed as a percentage of the total annular goove volume.

FIG. 14 shows a cross sectional view of the hex bit retained in the square hole 60. Occupied regions 66 are indicated.

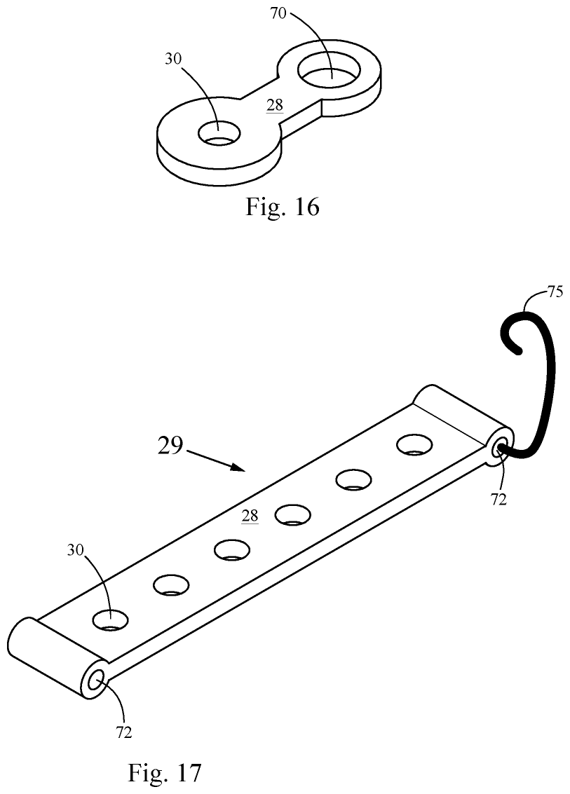

FIG. 16 shows an embodiment of the present invention having a single hole 30 for retaining a hex bit, and a loop hole 70 for hanging or attaching to a tool belt, keychain, carabiner, or power tool (e.g. impact driver or power drill). The storage device of FIG. 16 can be made of a single piece of rubber, molded, die cut, or punched for example.

FIG. 17 shows an embodiment of the present invention with transverse holes 72. The transverse holes 72 are aligned in the plane of the elastomeric sheet 28. The transverse holes 72 allow for storage and organization of the hex bit storage devices 29. For example, metal wire hanger 75 can be disposed in one of the transverse holes 72. The material around the transverse holes 72 can be the same material comprising the elastomeric sheet 28. The embodiment of FIG. 17 can be molded as a single piece of rubber for example.

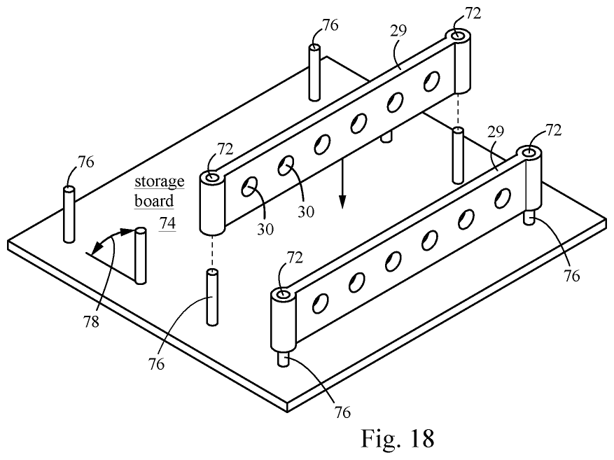

FIG. 18 shows a board 74 for organizing and storing the present hex bit storage devices 29. The storage board 74 is rigid and has rigid mounting pins 76. The board 74 and pins 76 can be made of metal, hard plastic (e.g. polypropylene, nylon, polarcarbonate or polyethylene) or wood for example. The mounting pins 76 are sized and positioned so that the pins 76 can slide into the transverse holes 72. The transverse holes 72 and pins 76 can be round/cylindrical (as shown) or can be any other shape such as square, hexagonal, or triagonal for example. The storage devices 29 can be disposed on and removed from the pins 76 by sliding vertically.

The pins 76 in FIG. 18 are perpendicular to the storage board 74, i.e. with angle 78 equal to 90 degrees. Alternatively, the angle 78 can be other than 90 degrees, such as 20, 110, 30, 120, 45, or 135 degrees for example. Pins 76 oriented at non-perpendicular angles may provide easier manual access to hex bits retained in the holes 30.

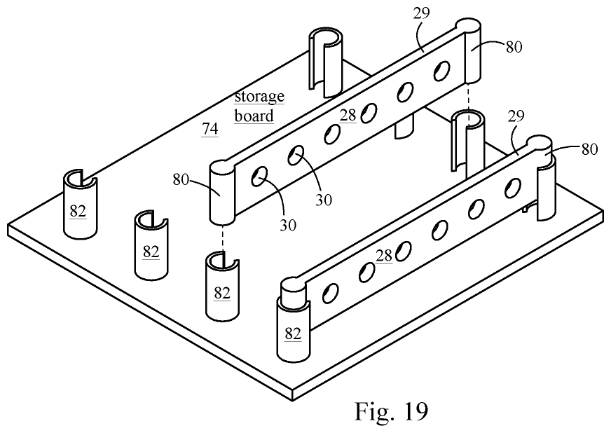

FIG. 19 shows an embodiment of the present invention in which the hex bit storage devices 29 have expanded ends 80 and the storage board 74 has receptacles 82 for holding the expanded ends 80. The storage devices 29 can be disposed in and removed from the receptacles 82 by sliding vertically. The expanded ends 80 have a round cylindrical shape, but this is not required in the invention. The expanded end 80 can have any other shape capable of interlocking with the receptacles 82. The receptacles can have a shape to match the shape of the expanded ends. For example the expanded ends 80 (and receptacles 82) can have shapes such as rectangular prism, hexagonal prism, polygonal prism, or oval cylinder for example. The expanded end 80 may be made integral with the elastomeric sheet 28. For example the elastomeric sheet 28 and expanded end 80 can be molded as a single piece of rubber.

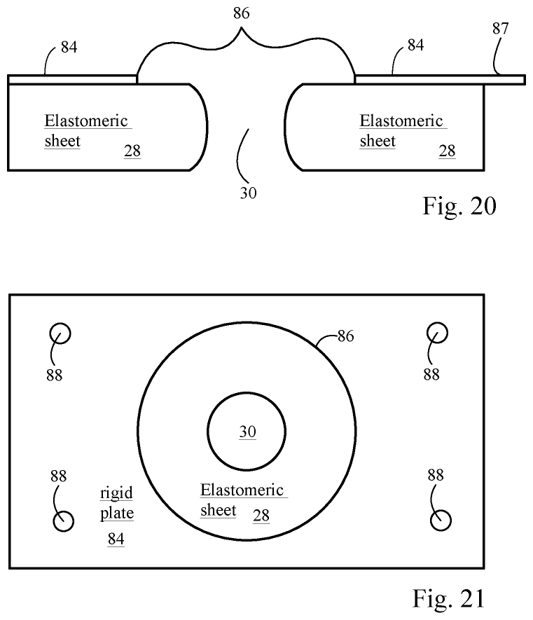

FIGS. 20 and 21 show a side view and a top view of an embodiment of the present invention in which a rigid plate 84 is attached to or disposed on the elastomeric sheet 28. The rigid plate 84 has an opening 86 so that the hole 30 is accessible. The opening 86 must be larger than the hole 30. For example, the opening can be 1.5-5×larger in diameter or surface area than the hole 30. The rigid plate can be made of metal, plastic, wood, or hard rubber (rubber that is harder than the elastomeric sheet 28). The rigid plate 84 can be mounted on or attached to (e.g. with screws) workspace furniture, or power tools for example. The rigid plate 84 may have a cantilevered part 87 extending beyond an edge of the elastomeric sheet 28. Also, the rigid plate 84 may have one or more screw holes 88 for mounting. A screw hole for mounting may be located in the cantilevered part 87.

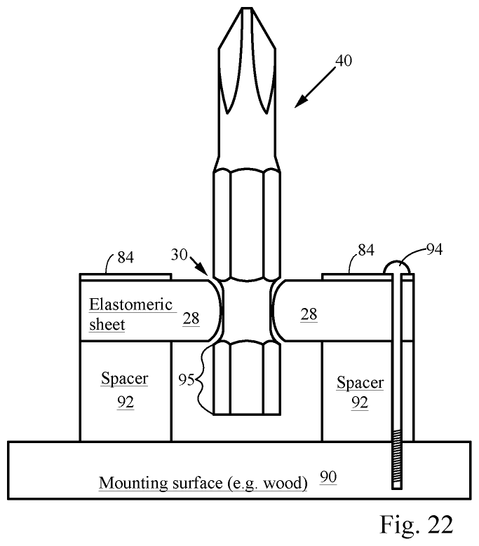

FIG. 22 shows an embodiment of the present invention attached to a mounting surface 90. The mounting surface 90 can be part of workplace furniture or other tools. This embodiment has spacers 92 that provide space for a bottom end 95 of the hex bit 40. The spacers can be made of metal or hard plastic for example. A screw 94 extends through the rigid plate 84, through the spacer 92 and into the mounting surface 90. The screw 94 compresses the elastomeric sheet 28 between the rigid plate 84 and the spacer 92. The rigid plate 84 does not need to extend around the hole 30. The rigid plate can comprise a metal washer for example. In use, the hex bit 40 can be conveniently stored with one hand by pressing the bottom end 95 into the hole. The hex bit 40 can be retrieved with one hand by pulling it from the hole 30.

The rigid plate 84 is optional in the embodiment of FIG. 22. If the rigid plate 84 is not present, the elastomeric sheet 28 can be bonded to the spacer 92. The spacer 92 and elastomeric sheet 28 can comprise a single integral part and made of the same material (e.g., rubber).

What is claimed is:

1. A hex bit storage device, comprising:
a) a hex bit comprising an annular groove, wherein the hex bit has a minor diameter;
b) an elastomeric sheet having at least one hole for storing the hex bit, wherein the hole extends through the elastomeric sheet, and wherein the hole has a minimum inner diameter that is smaller than the minor diameter, and wherein the annular groove is disposed in the hole.

2. The hex bit storage device of claim 1 wherein the elastomeric sheet has a thickness less than a length of the annular groove in a plane of the major diameter.

3. The hex bit storage device of claim 1 wherein the holes have an hourglass shape.

4. The hex bit storage device of claim 1 wherein the holes have an asymmetrical hourglass shape.

5. The hex bit storage device of claim 1 wherein the elastomeric sheet has a hardness of 20-60 shore A.

6. The hex bit storage device of claim 1 further comprising a transverse hole at one end of the storage device.

7. The hex bit storage device of claim 1 further comprising an expanded end at one end of the storage device.

8. A hex bit storage device for storing hex bits having an annular groove, comprising:
a) a hex bit comprising an annular groove, wherein the hex bit has a minor-diameter cross sectional groove area, and a major-diameter cross sectional groove area;
b) an elastomeric sheet having at least one hole for storing the hex bit, wherein the hole extends through the elastomeric sheet, and
wherein the annular groove is disposed in the hole, and wherein the elastomeric sheet overlaps at least 20% of the major-diameter cross sectional groove area.

9. The hex bit storage device of claim 8 wherein the elastomeric sheet overlaps at least 40% of the major diameter cross sectional groove area.

10. The hex bit storage device of claim 8 wherein the elastomeric sheet overlaps at least 20% of the minor diameter cross sectional groove area.

11. The hex bit storage device of claim 8 wherein the elastomeric sheet overlaps at least 40% of the major diameter cross sectional groove area.

12. The hex bit storage device of claim 8 wherein the elastomeric sheet has a thickness less than a length of the annular groove in a plane of the major diameter.

13. The hex bit storage device of claim 8 wherein the holes have an hourglass shape.

14. The hex bit storage device of claim 8 wherein the holes have an asymmetrical hourglass shape.

15. The hex bit storage device of claim 8 further comprising a transverse hole attached to the elastomeric sheet.

16. The hex bit storage device of claim 8 further comprising an expanded end attached to the elastomeric sheet.

17. A hex bit storage device for storing a hex bit having an annular groove with dimensions in accordance with ASME B107.4, wherein the annular groove has a major-diameter cross sectional groove area, and has a minor-diameter cross sectional groove area, the storage device comprising:
a) an elastomeric sheet having at least one hole for storing the hex bit, wherein the hole extends through the elastomeric sheet, wherein the hole is shaped and sized such that the elastomeric sheet overlaps at least 20% of the major-diameter cross sectional groove area when the annular groove is disposed in the hole.

18. The hex bit storage device of claim 17 wherein the elastomeric sheet overlaps at least 40% of the major diameter cross sectional groove area.

19. The hex bit storage device of claim 17 wherein the elastomeric sheet overlaps at least 50% of the major diameter cross sectional groove area.

20. The hex bit storage device of claim 17 wherein the elastomeric sheet overlaps at least 30% of the minor diameter cross sectional groove area.

21. The hex bit storage device of claim 17 wherein the elastomeric sheet overlaps at least 50% of the minor diameter cross sectional groove area.

22. The hex bit storage device of claim 17 wherein the elastomeric sheet has a thickness less than a length of the annular groove in a plane of the major diameter.

23. The hex bit storage device of claim 17 wherein the holes have an hourglass shape.

24. The hex bit storage device of claim 17 wherein the holes have an asymmetrical hourglass shape.

25. The hex bit storage device of claim 17 further comprising a transverse hole attached to the elastomeric sheet.

26. The hex bit storage device of claim 17 further comprising an expanded end attached to the elastomeric sheet.

27. A hex bit storage device for storing hex bits having an annular groove, comprising:
a) a hex bit comprising an annular groove, wherein the annular groove has a 3-dimensional volume;
b) an elastomeric sheet having at least one hole for storing the hex bit, wherein the hole extends through the elastomeric sheet, and
wherein the annular groove is disposed in the hole, and wherein the elastomeric sheet occupies at least 10% of the annular groove volume for any rotational orientation of the hex bit.

28. The hex bit storage device of claim 27 wherein the holes are non-circular.

29. The hex bit storage device of claim 27 wherein the holes have a polygonal shape.

30. The hex bit storage device of claim 27 wherein the holes are triangular, square, oval, pentagonal or hexagonal.

31. The hex bit storage device of claim 27 wherein the elastomeric sheet occupies at least 20% of the annular groove volume for any rotational orientation of the hex bit.

32. The hex bit storage device of claim 27 wherein the elastomeric sheet occupies at least 50% of the annular groove volume for any rotational orientation of the hex bit.

33. The hex bit storage device of claim 27 further comprising a transverse hole attached to the elastomeric sheet.

34. The hex bit storage device of claim 27 further comprising an expanded end attached to the elastomeric sheet.

35. A hex bit storage device for storing a hex bit having an annular groove with dimensions in accordance with ASME B107.4, wherein the annular groove has a 3-dimensional volume, the storage device comprising:
a) an elastomeric sheet having at least one hole for storing the hex bit, wherein the hole extends through the elastomeric sheet, and wherein the hole is shaped and sized such that the elastomeric sheet occupies at least 10% of the annular groove volume of the annular groove when the annular groove is disposed in the hole.

36. The hex bit storage device of claim 35 wherein the holes are non-circular.

37. The hex bit storage device of claim 35 wherein the holes have a polygonal shape.

38. The hex bit storage device of claim 35 wherein the holes are triangular, square, oval, pentagonal or hexagonal.

39. The hex bit storage device of claim 35 wherein the elastomeric sheet occupies at least 20% of the annular groove volume.

40. The hex bit storage device of claim 35 wherein the elastomeric sheet occupies at least 40% of the annular groove volume.

41. The hex bit storage device of claim 35 wherein the elastomeric sheet occupies at least 50% of the annular groove volume.

42. The hex bit storage device of claim 35 further comprising a transverse hole attached to the elastomeric sheet.

43. The hex bit storage device of claim 35 further comprising an expanded end attached to the elastomeric sheet.
